(19) United States
(12) Patent Application Publication
(10) Pub. No.: US 2025/0170655 A1
(43) Pub. Date: May 29, 2025

(54) Tool, cutting arrangement for a tool, and method for manufacturing a tool

(71) Applicant: Kennametal Inc., Latrobe, PA (US)

(72) Inventors: Sebastian Schleicher, Fuerth (DE); Konrad Spitzenberger, Fuerth (DE); Andreas Lieber, Fuerth (DE)

(21) Appl. No.: 18/952,480

(22) Filed: Nov. 19, 2024

(30) Foreign Application Priority Data
Nov. 28, 2023 (DE) 1020232118807

(51) Int. Cl. B23B 29/04; B23B 27/16

(52) U.S. Cl. CPC B23B 29/04; B23B 27/1614; B23B 2205/12; B23B 2205/16; B23B 2250/12

(57) ABSTRACT

A tool is specified, which comprises a holder, which comprises at least one cutting arrangement for processing a workpiece, wherein the holder comprises at least one insert seat in which the cutting arrangement is mounted, wherein the holder comprises a first medium channel for conducting a coolant and/or lubricant (M), wherein the first medium channel comprises a first outlet opening which is arranged at least partially within the insert seat, wherein the cutting arrangement comprises a second medium channel, which is connected to the first medium channel and which comprises at least one second outlet opening arranged in a lateral surface of the cutting arrangement. Further specified are a cutting arrangement and a method for manufacturing a tool.

### RELATED APPLICATION DATA

The present application claims priority pursuant to 35 U.S.C. § 119(a) to Germany Application Number 1020232118807 filed Nov. 28, 2023, which is incorporated herein by reference in its entirety.

### FIELD

The invention relates to a tool, in particular a rotary tool, a cutting arrangement for such a tool, and a method for manufacturing such a tool, specifically a holder thereof.

### BACKGROUND

Tools can be designed to be modular and then comprise interchangeable cutting arrangments mounted on a tool holder. The cutting arrangments are typically plate-shaped, so that the corresponding mounting positions on the holder are referred to as insert seats. A cutting arrangement may be a simple cutting insert (or just “insert”) or a combination of such a cutting insert comprising a shim, which is also typically plate-shaped.

When using a tool comprising interchangeable cutting arrangments, it is desirable to supply coolant and/or lubricant, depending on the application. For this purpose, corresponding medium channels are, e.g., incorporated into the holder and lead to the vicinity of the cutting arrangments in order to discharge a coolant and/or lubricant in that location.

Reference is made to US 8 439 608 B2.

### SUMMARY

Against this background, the object of the invention is to improve the supply of a coolant and/or lubricant to the cutting arrangments in a tool using interchangeable cutting arrangments. The tool itself should be as simple as possible in terms of design. Specified for this purpose are a correspondingly improved tool, an improved cutting arrangement for this purpose, and a method for manufacturing such a tool.

Said object is achieved by means of a tool having the features according to claim 1, a cutting arrangement having the features according to claim 12 and a method having the features according to claim 13. Advantageous embodiments, further developments, and variants are the subject of the dependent claims. The information provided in relation to the tool also applies to the cutting arrangement and the method, and vice versa.

The tool comprises a holder and at least one cutting arrangement for processing a workpiece. Typically, the tool comprises multiple cutting arrangments, in particular of the same type, which are distributed regularly or irregularly and in one or multiple planes along the holder. The holder comprises at least one insert seat in which the cutting arrangement is mounted. In particular, the tool comprises exactly one insert seat for each cutting arrangement. In one suitable embodiment, the holder comprises a base body and one or multiple arms (also known as a tooth base). The base body is generally cylindrical and in particular solid, the arms then each forming a cantilever on the base body in a radial direction. One or multiple insert seats are then integrated into each arm.

The tool is preferably a rotary tool, meaning that the holder and thus also the cutting arrangments rotate around a longitudinal axis (also: axis of rotation) during operation to process the workpiece. The longitudinal axis extends in an axial direction; perpendicular to it is a radial direction. The tool rotates in a circumferential direction (tangential direction) around the longitudinal axis. The tool is preferably a milling and/or drilling tool, which will be assumed in the following without loss of generality. In principle, the following explanations also apply accordingly to other tools, e.g. cutting tools, to which the invention described herein can also be applied.

The insert seat comprises a base that preferably points in the circumferential direction and is then also referred to as a tangential surface. This will be assumed hereinafter without loss of generality. Alternatively, the base points in a different direction, e.g. in a radial direction, so that the cutting arrangement then sits tangentially in the insert seat. Optionally, the insert seat comprises one or multiple lateral surfaces that extend laterally from the base and point, for example, generally in the axial or radial direction or a combination thereof. The cutting arrangement is generally plate-shaped and comprises a rear side that adjoins the base. This side is also referred to as the tangential surface due to the resulting alignment. Furthermore, the cutting arrangement comprises a front side, which is opposite the rear side. In addition, depending on the design, the cutting arrangement comprises one or multiple lateral surfaces that connect the front side to the rear side. For example, a square cutting arrangement comprises four lateral surfaces, specifically two radial surfaces (pointing in the radial direction) and two axial surfaces (pointing in the axial direction).

The cutting arrangement comprises at least one, typically multiple, cutting edges that border the front side. The lateral surfaces connect to the cutting edges and are thus also clearance surfaces, meaning that, during processing, each lateral surface forms a clearance angle with the workpiece. However, embodiments are also conceivable in which one lateral surface is not or is only partially bordered by a cutting edge and then, accordingly, does not or only partially represents a clearance surface.

The holder comprises an initial medium channel for conducting a coolant and/or lubricant. The coolant and/or lubricant is also referred to simply as the “medium”. The medium is typically liquid. The first medium channel comprises (at least or exactly) one first outlet opening, which is at least partially arranged in the insert seat. If there are multiple insert seats, the tool comprises a corresponding number of first medium channels, each of which leads to one of the insert seats. The first medium channel lies entirely within the holder. The first outlet opening, for example, is round or elliptical. The first outlet opening in particular is completely covered by the cutting arrangement. The first medium channel extends in particular through both the base body of the holder and one of the arms and to the insert seat integrated therein.

The cutting arrangement then comprises a second medium channel, which is connected to the first medium channel and which comprises at least a second outlet opening, which is arranged in a lateral surface, in particular a clearance surface, of the cutting arrangement. The second medium channel also comprises a second inlet opening, through which the medium passes from the first outlet opening of the first medium channel into the second medium channel. The first outlet opening and the second inlet opening are in particular directly adjacent to one another, but this is not absolutely necessary. The second outlet opening can basically be any desired shape, but a circular or elliptical shape is particularly suitable.

The tool then comprises a total of two medium channels, specifically the first medium channel of the holder and the second medium channel of the cutting arrangement. These two medium channels are connected to each other in a fluidic manner, meaning that the medium first flows through the first medium channel, is then transferred from there to the second medium channel, and finally discharged via the lateral surface of the cutting arrangement. In particular, the tool comprises such a pair of a first and a second medium channel for each individual cutting arrangement.

The terms “first” and “second” in connection with inlet and outlet openings are in this context used to indicate whether the respective inlet or outlet opening belongs to the first or second medium channel and are not to be understood as numbers, meaning that, although the second medium channel comprises a second outlet opening, it comprises no first outlet opening.

The cutting arrangement is preferably rotationally symmetrical, i.e. designed as an indexable cutting arrangement, in particular with regard to the cutting edges of the cutting arrangement, but especially with regard to the design of the second medium channel, so that it features the same rotational symmetry as the arrangement of the cutting edges.

One important aspect of the present invention is in particular that the cutting arrangement itself comprises a medium channel (specifically the second medium channel), through which the medium is conducted, and then discharged at a suitable point. In this case, the suitable location is the lateral surface of the cutting arrangement, which is preferably even a clearance surface of the cutting arrangement. Therefore, discharge of the medium occurs in particular in the axial and/or radial direction, in contrast to discharge in the circumferential direction (i.e., in the tangential direction). The lateral surface is situated beneath a cutting edge of the cutting arrangement, which runs ahead of clearance surface during operation. By means of the present invention, a discharge of the medium on the clearance surface of the cutting arrangement is then achieved. A discharge of the medium at this point, i.e. on the lateral surface, is not described in particular in the US 8 439 608 B2 cited at the beginning and is particularly advantageous for rotary tools, for which, in contrast to stationary tools, e.g. cutting tools, other challenges arise when supplying a coolant and/or lubricant.

In addition, the design of the cutting arrangement is particularly simple, in contrast to the holder, and opens up a wide range of possible designs, enabling the medium to be conducted and discharged as desired. Whereas the first medium channel for the tool is firmly specified by the holder, the second medium channel can be changed accordingly and adapted to the respective application by simply exchanging the cutting arrangement. The appropriate cutting arrangement need only be selected, which then discharges the medium at the desired point through the correspondingly designed second medium channel.

In particular, two preferred varients exists for the cutting arrangement, which will be explained in more detail in the following.

In the first preferred variant, the cutting arrangement is made up of a single part (i.e., monolithic), specifically as a cutting insert (or simply “insert”). The cutting arrangement thus consists of only a single cutting insert. This cutting insert is mounted directly in the insert seat and comprises a rear side, by way of which the cutting insert adjoins a base of the insert seat. Optionally, the cutting insert also adjoins, by way of at least one lateral surface, a lateral surface of the insert seat.

In a second preferred variant, however, the cutting arrangement is made up of multiple parts, specifically a combination of a cutting insert and a shim. The shim is arranged between the cutting insert and the base of the insert seat. The shim space the cutting insert from the base of the insert seat, specifically by a height of the shim. In this second embodiment, the second medium channel extends through the shim. In this case, a design in which the second medium channel is completely formed in the shim and/or in which the cutting insert is free of any medium channels is preferred. However, other designs are also possible and equally suitable, in which the second medium channel extends partly through the shim and partly through the cutting insert.

The shim is completely covered by the cutting insert. Preferably, the shim is shaped identically to the rear side of the cutting insert.

In one particularly advantageous embodiment, the second medium channel is formed by means of a groove that extends along a rear side of the cutting insert. In this context, it is particularly important that the groove is open and that the second medium channel is only formed as a closed channel when it is combined with the insert seat (the second medium channel itself, however, remains open at the second inlet opening and the second outlet opening). The second medium channel thus comprises a wall that is formed, on the one hand, by the groove of the cutting insert and, on the other hand, by the insert seat. This kind of groove is particularly easy to manufacture and is, e.g., simply formed by a corresponding press or casting mold during manufacture of the cutting insert. It is not necessary to drill a separate bore after the cutting insert is formed; the groove is formed directly when the cutting insert is formed. The cutting insert is therefore preferably a pressed or cast part.

In principle, the groove can be of any desired shape, as long as it leads from the first outlet opening of the first medium channel to the lateral surface of the cutting arrangement and is at least partially covered by the insert seat. For example, the groove has an S-shape. Preferably, the groove is rotationally symmetric corresponding to a rotational symmetry of the cutting arrangement.

The previously specified embodiment, in which the second medium channel is formed by means of a groove on the rear side of the cutting insert, can also be combined with a shim, which then completes the wall of the second medium channel instead of the insert seat. Or, the front side of the shim itself comprises a second groove for this purpose (in particular complementary to the groove of the cutting insert), which for example simply follows the same course as the groove of the cutting insert. The concept of the groove on the rear side can also be advantageously applied to the shim, so that it then comprises a rear side, regardless of the design of the cutting insert, in which the second medium channel is formed by means of a groove. Accordingly, one preferred embodiment is then achieved by the second medium channel generally being formed by means of a groove which extends along a rear side of the cutting arrangement. Similarly, it is also possible and advantageous for the second medium channel to be formed by means of a groove extending along one front side of the shim. In this case, the wall of the second medium channel is formed by the groove of the shim on the one hand and the rear side of the cutting insert on the other. The cutting insert need not be specially designed; a conventional cutting insert with a flat rear side can be used.

Especially in the case of the shim, however, it is also possible to design the second medium channel to be immediately closed, and not as an open groove as described hereinabove because, due to the material of which the shim is typically made, different manufacturing methods can be used for its production than for the cutting insert. Whereas the cutting insert, for example, is a pressed part made of a special ceramic, the shim is simply made of a high-strength steel and is in any case preferably made of a harder material than the holder. In one particularly preferred embodiment, the shim is produced in an additive manufacturing method, e.g. by means of 3D printing as a 3D printed part. It is thus possible to achieve almost any course for the second medium channel.

The insert seat and/or the cutting arrangement advantageously comprise a deflection contour, which is arranged such that the coolant and/or lubricant emerging from the second outlet opening strikes the deflection contour. The deflection contour then at least redirects the medium, and advantageously also distributes or atomizes it, in particular immediately after it emerges from the second medium channel. The deflection contour is, for example, an edge, a projection, a spike, a step, a shoulder, or the like. The deflection contour enables the distribution of the medium to be further shaped in the clearance surface. The deflection contour can be used for both single-part and multi-part cutting arrangments.

Alternatively or in addition to the deflection contour, the lateral surface of the cutting arrangement is designed for the purpose of redirecting, distributing, or atomizing the medium, or the like. For example, one or multiple grooves are formed in the lateral surface starting from the second outlet opening, or the lateral surface has a special surface profile at least in the vicinity of the second outlet opening, which further influences the conducting and/or distribution of the medium after emerging from the second medium channel.

The transfer of the medium from the first medium channel to the second medium channel can, in principle, be performed in various ways, which can also be combined by, e.g., providing multiple first outlet openings distributed in an appropriate manner. In one suitable embodiment, the insert seat comprises a lateral surface (e.g., radial or axial), which adjoins the cutting arrangement by way of a lateral surface and in which the first outlet opening is arranged. The transfer of the medium then occurs from lateral surface to lateral surface, in particular in the radial or axial direction or a combination thereof. The second medium channel preferably extends only sideways, from one lateral surface to the other lateral surface of the cutting arrangement. Alternatively or additionally, the insert seat comprises a base, which the rear side of the cutting arrangement adjoins (as already described) and in which the first outlet opening is then arranged. The transfer then takes place in a circumferential direction (direction of rotation). The second medium channel thereby extends, e.g., diagonally through the cutting arrangement, from the rear side to the lateral surface, or as a groove in the rear side and then parallel to it.

The position of the first outlet opening in the insert seat is independent of the specific design of the cutting arrangement, with or without a shim, and also independent of the specific design of the second medium channel (open groove or closed channel, as well as the specific course). Accordingly, these individual aspects can be combined with one another as desired.

In one suitable embodiment, the insert seat comprises a bore (e.g., internal thread) for a fastening means (e.g., screw) for mounting the cutting arrangement on the holder. Accordingly, the entire cutting arrangement (i.e., optionally including the shim) comprises a clearance hole for the fastening means. The bore comprises a depression, in particular at the end, facing the cutting arrangement, in which the first outlet opening is at least partially arranged. The first medium channel consequently flows into the depression of the bore, from where a particularly effective transfer of the medium is possible, in particular to other points than just the second medium channel.

Particularly preferred is a design in which the first medium channel is straight, i.e. completely straight. Correspondingly, the first medium channel is not curved. The first medium channel is then, for example, a simple bore in the holder and therefore particularly easy to produce. When manufacturing the tool, especially the holder, the first medium channel is then simply produced as a single bore in the holder. The first medium channel is suitably designed to have a constant diameter, meaning that it is not tapered, but such a design is nevertheless fundamentally suitable.

Also particularly preferred is an embodiment in which the at least one cutting arrangement is a first cutting arrangement and in which the tool comprises a second cutting arrangement which, viewed in the circumferential direction, runs behind the first cutting arrangement. The holder then comprises a radial channel for cooling the cutting surface of the second cutting arrangement. The radial channel extends in the radial direction and in particular from a central channel of the holder. This central channel extends along the longitudinal axis and conducts the medium to the radial channel. It is advantageous to form a corresponding radial channel for each insert seat in the holder. The radial channel comprises a (third) outlet opening that ejects the medium onto the front side of a respective cutting arrangement. Correspondingly, the radial channel does not in particular lead into the associated insert seat. The front side corresponds to a cutting surface of the cutting arrangement. The radial channel is preferably designed as a simple, straight bore. In this respect, the explanations hereinabove regarding the first medium channel also apply to the radial channel, but in the opposite direction. The first medium channel then starts from the radial channel, meaning that a branch for the medium is formed inside the holder, at which a first part of the medium is conducted to the cutting surface of the first cutting arrangement, and a second part of the medium is branched off to the clearance surface of the second cutting arrangement. This design is particularly easy to manufacture, especially given a simple, straight bore as the first medium channel. In general, the first medium channel comprises a first inlet opening through which the medium flows into the first medium channel. The first medium channel is then connected to the radial channel via this inlet opening.

Alternatively or in addition to a connector to a radial channel, the first medium channel is connected directly to the central channel.

### BRIEF DESCRIPTION OF THE DRAWINGS

Exemplary embodiments of the invention are explained in more detail hereinafter with reference to the drawings. Schematically shown are:

FIG. 1 a tool,

FIG. 2 a sectional view of the tool shown in FIG. 1,

FIG. 3 a detailed view of a cutting arrangement of the tool from FIG. 1,

FIG. 4 a front view of the tool shown in FIG. 1,

FIG. 5 a first sectional view of the tool from FIG. 4,

FIG. 6 a second sectional view of the tool from FIG. 4,

FIG. 7 a perspective view of the cutting arrangement in FIG. 3,

FIG. 8 another perspective view of the cutting arrangement from FIG. 3,

FIG. 9 a rear view of the cutting arrangement from FIG. 3,

FIG. 10 a lateral view of the cutting arrangement from FIG. 3,

FIG. 11 a sectional view of a variant of the tool from FIG. 1,

FIG. 12 a detailed view of a cutting arrangement of the tool shown in FIG. 11,

FIG. 13 a different view of the tool from FIG. 11,

FIG. 14 a sectional view of the tool in FIG. 11 without the cutting arrangement,

FIG. 15 a shim of the cutting arrangement from FIG. 12,

FIG. 16 a detailed view of an insert seat of a variant of the tool from FIG. 1.

### DETAILED DESCRIPTION

Two exemplary embodiments of a tool 2 are shown in the drawings. The tool 2 comprises a holder 4 and at least one, in this case multiple cutting arrangments 6, for processing a workpiece (not shown). In the exemplary embodiments shown herein, the tool 2 comprises multiple similar cutting arrangments 6, which are regularly distributed in one plane along the holder 4. The holder 4 also comprises a corresponding number of insert seats 8 in which the cutting arrangments 6 are mounted. The tool 2 comprises exactly one insert seat 8 for each cutting arrangement 6. The holder 4 comprises a base body 10 and multiple arms 12 (also known as tooth feet). The base body 10 is generally cylindrical and solid, with the arms 12 then each forming a cantilever on the base body 10 in the radial direction R. An insert seat 8 is integrated into each arm 12.

The tools 2 shown in this case by way of example are rotary tools, meaning that the holder 4 and the cutting arrangements 6 rotate during operation about a longitudinal axis L, which extends in an axial direction A. Perpendicular to the latter is the radial direction R. The tool rotates in a circumferential direction U (tangential direction) around the longitudinal axis L. The tools 2 shown herein are milling and/or drilling tools, but the explanations provided herein also apply to other tools.

Each insert seat 8 comprises a base 14, which generally points in the circumferential direction U. Optionally, the insert seat 8 comprises one or multiple lateral surfaces 16 that extend laterally from the base 14. The cutting arrangement 6 is generally plate-shaped and comprises a rear side 18, which adjoins the base 14 and is referred to as a tangential surface due to the resulting orientation. Furthermore, the cutting arrangement 6 comprises a front side 20 opposite the rear side 18. In addition, the cutting arrangement 6 comprises multiple lateral surfaces 22, 24 that connect the front side 20 to the rear side 18. The drawings show, by way of example, square cutting arrangments 6 comprising four lateral surfaces 22, 24, specifically comprising two radial surfaces 22 (pointing in the radial direction R) and two axial surfaces 24 (pointing in the axial direction A).

A respective cutting arrangement 6 comprises at least one, typically multiple (in this case four) cutting edges 26, which border the front side 20. The lateral surfaces 22, 24 adjoin the cutting edges 26 and are thus also clearance surfaces, meaning that a respective lateral surface 22, 24 forms a clearance angle with the workpiece during processing.

The holder 4 comprises a first medium channel 28 for conducting a coolant and/or lubricant M, which is also simply abbreviated as “medium” M. The medium M is typically liquid. The first medium channel 28 comprises a first inlet opening 30 and a first outlet opening 32, whereby the latter is arranged at least partially in one of the insert seats 8. In the case of multiple insert seats 8, the tool 2 comprises a corresponding number of first medium channels 28. The first medium channel 28 is situated completely within the holder 4. The first outlet opening 32, for example, is round or elliptical and is completely hidden by the cutting arrangement 6 in the present case. The first medium channel 28 extends through both the base body 10 and one of the arms 12 and to the insert seat 8 integrated therein.

The cutting arrangement 6 then comprises a second medium channel 34, which connects to the first medium channel 28 and which comprises at least one second inlet opening 36 and at least one second outlet opening 38, whereby the latter is arranged in one of the lateral surfaces 22, 24 of the cutting arrangement 6. The medium M enters the second inlet opening 36 and passes from the first outlet opening 32 of the first medium channel 28 into the second medium channel 34. The first outlet opening 32 and the second inlet opening 36 directly adjoin one another, but this is not absolutely necessary. In principle, the second outlet opening 38 can have any desired shape, e.g. a circular or elliptical shape.

The cutting arrangments 6 shown in this case by way of example are rotationally symmetrical, i.e., designed as reversible cutting arrangments, especially with regard to the cutting edges 26, but also especially with regard to the design of the second medium channel 34, so that it features the same rotational symmetry as the arrangement of the cutting edges 26.

A respective cutting arrangement 6 thus itself comprises a medium channel 34 (specifically the second medium channel 34), through which the medium M is conducted, and then discharged on the lateral surface 22, 24, which is actually a clearance surface of the cutting arrangement 6. A discharge of the medium M thus occurs in the axial and/or radial direction A, R, in contrast to a discharge in the circumferential direction U (i.e., in the tangential direction). The lateral surface 22, 24 is accordingly situated below a cutting edge 26 of the cutting arrangement 6. This cutting edge 26 runs ahead of the corresponding lateral surface 22, 24 during operation. This then achieves a discharge of the medium M, specifically on the clearance surface of the cutting arrangement 6.

Two possible variants for the cutting arrangement 6 are explained in more detail hereinafter.

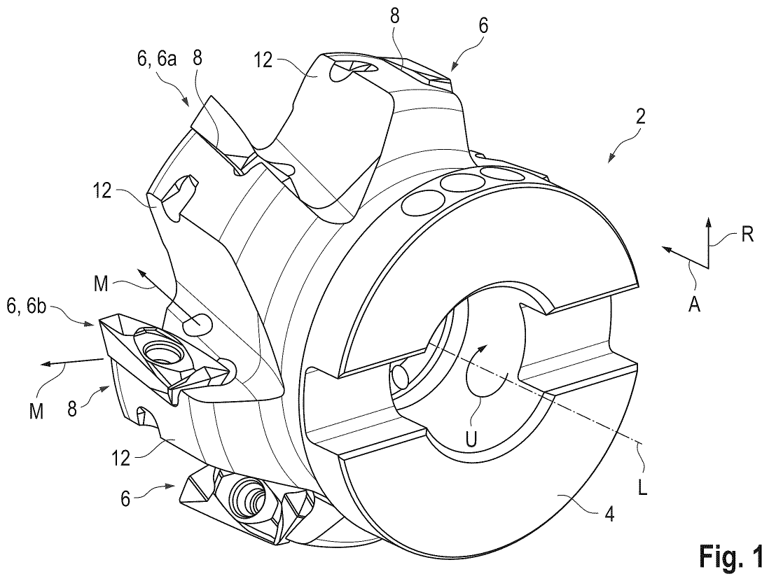

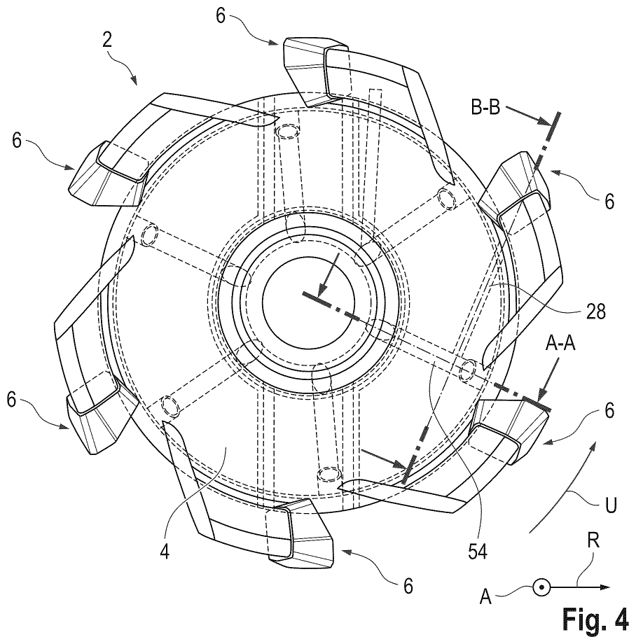

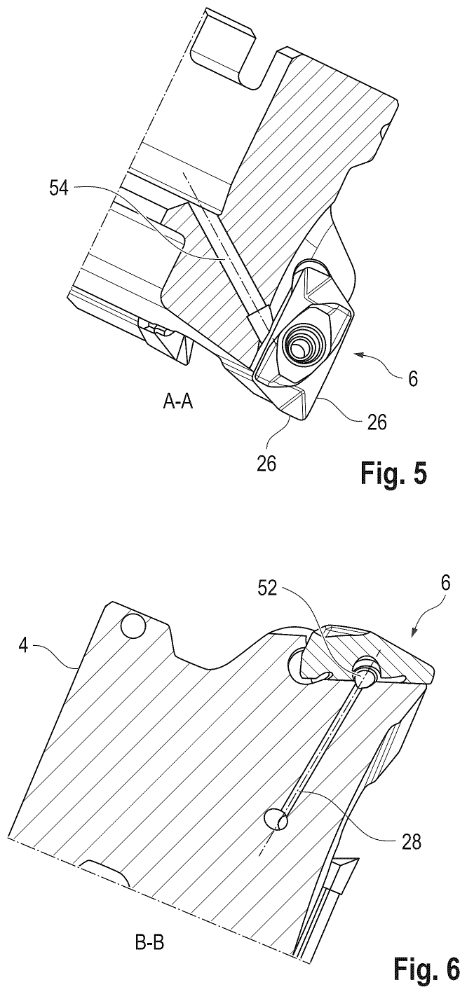

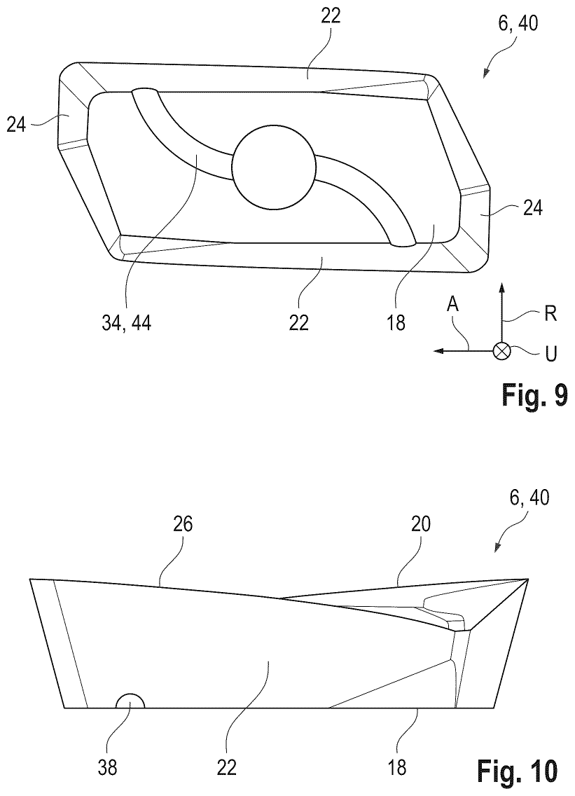

In the first possible variant, the cutting arrangement 6—as shown in FIGS. 1 to 10—is made up of a single part (i.e., monolithic), specifically as a cutting insert 40 (“cutting insert” or just “insert”). The cutting arrangement 6 thus consists only of a single cutting insert 40, which is mounted directly in the insert seat 8 and comprises a rear side 18 that adjoins the base 14 of the insert seat 8. Optionally, the cutting insert 40—as shown in this drawing—also adjoins, by way of a lateral surface 22, 24, a lateral surface 16 of the insert seat 8.

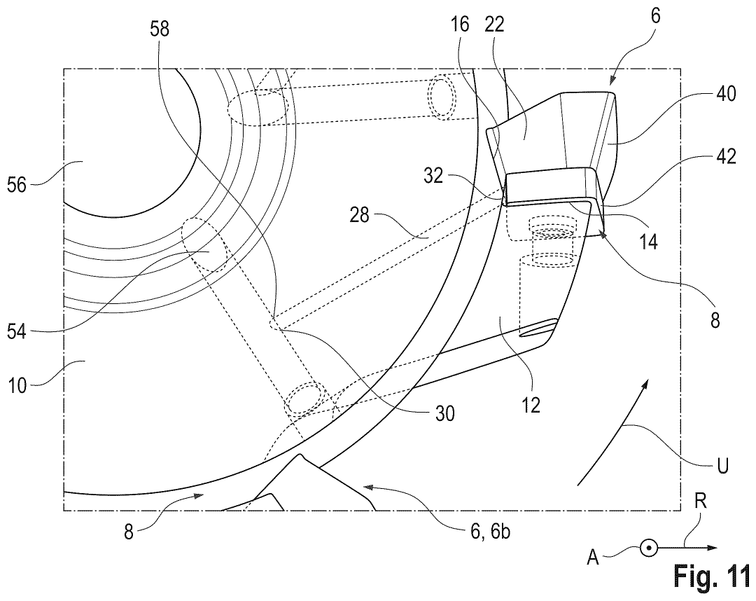

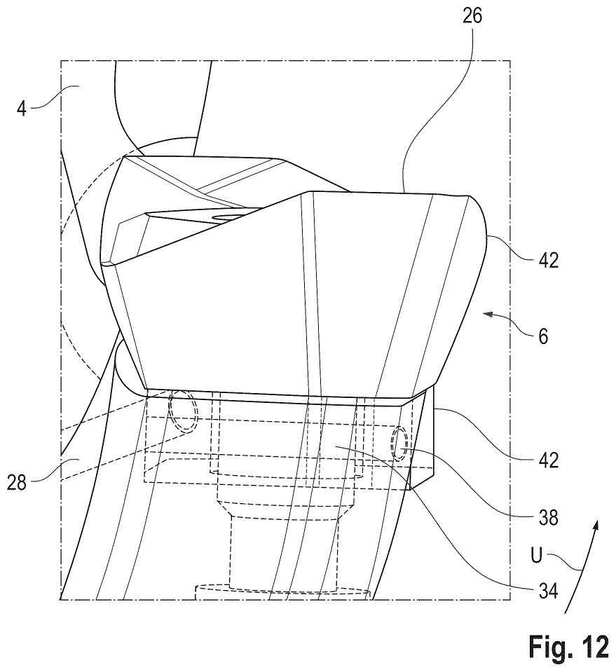

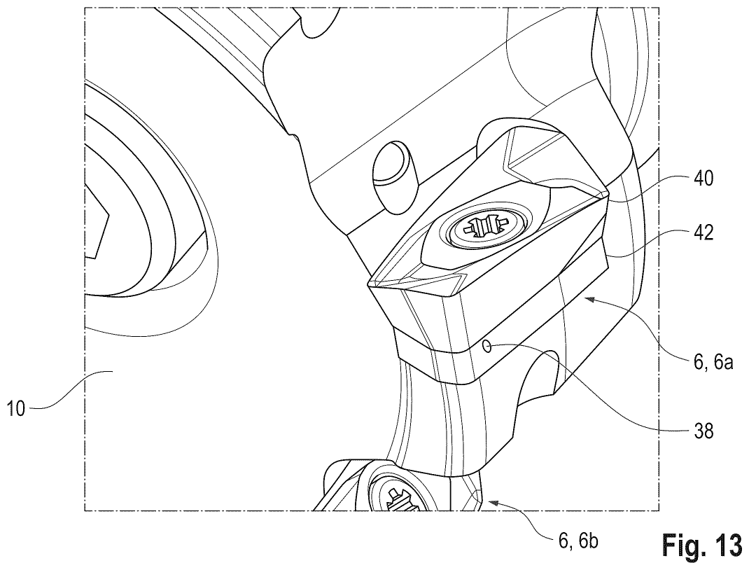

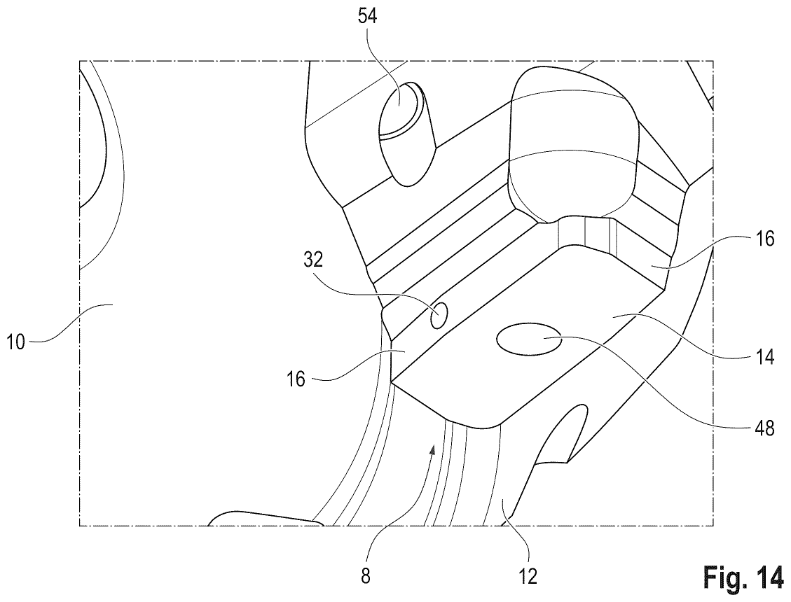

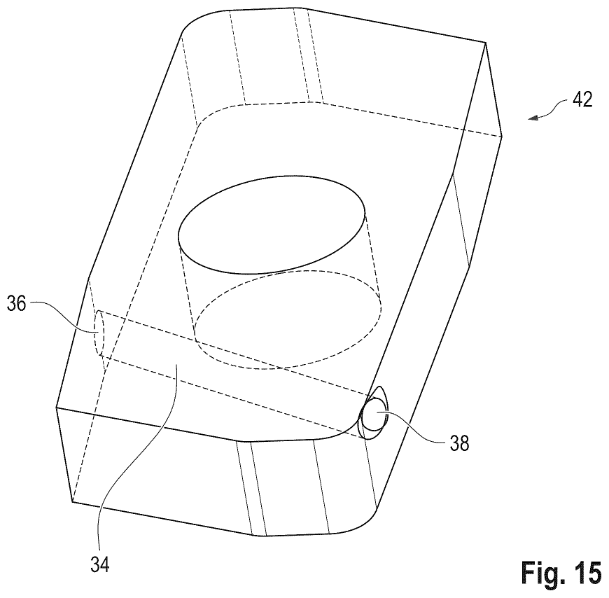

In a second possible variant, the cutting arrangement 6—as shown in FIGS. 11 to 15—is, on the other hand, made up of multiple parts, specifically as a combination of a cutting insert 40 and a shim 42. The shim 42 is in this case arranged between the cutting insert 40 and the base 14 of the insert seat 8. Due to the shim 42, the cutting insert 40 is at a distance from the base 14, specifically by a height corresponding to the shim 42. In this second variant, the second medium channel 34 extends through the shim 42. In the embodiment shown in this case, the second medium channel 34 is actually fully formed in the shim 42, and the cutting insert 40 has no medium channels. However, it is also possible and likewise suitable to use embodiments that are not explicitly shown herein, in which the second medium channel 34 extends partly through the shim 42 and partly through the cutting insert 40.

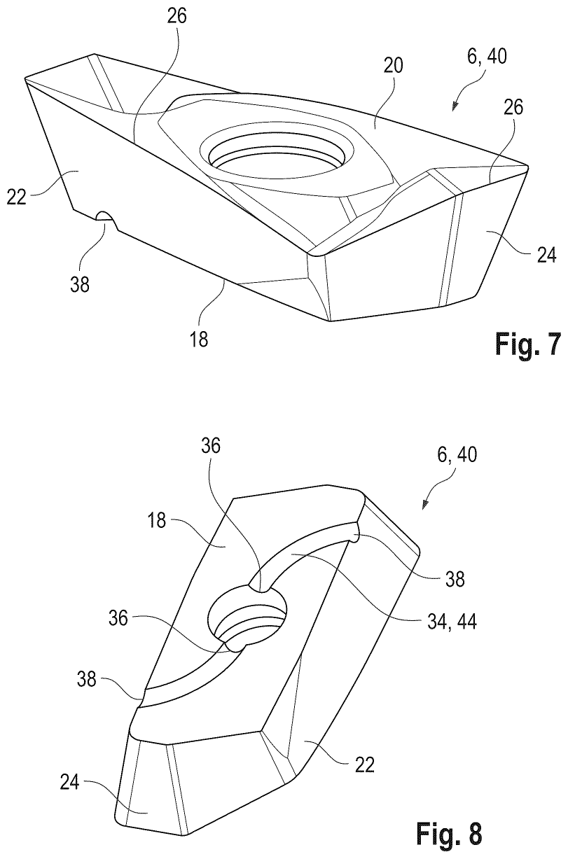

In the exemplary embodiment in FIGS. 1 to 10, the second medium channel 34 is formed by means of a groove 44 that extends along the rear side 18 of the cutting insert 40. This is particularly evident in FIGS. 7 to 10. It is thereby essential that the groove 44 is open and that the second medium channel 34 is only formed as a closed channel in combination with insert seat 8. The second medium channel 34 therefore comprises a wall that is formed, on the one hand, by the groove 44 of the cutting insert 40 and, on the other hand, by the insert seat 8. The groove 44 is, e.g., formed directly during the shaping of the cutting insert 40.

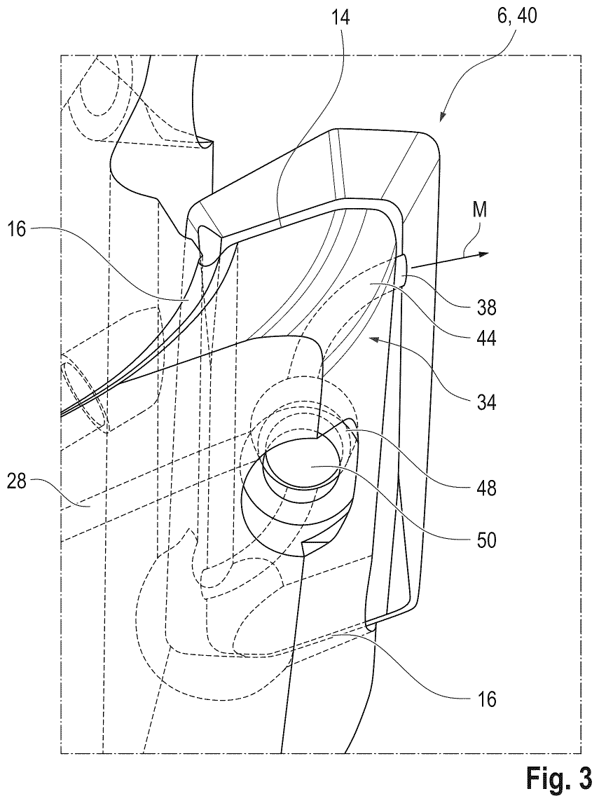

The groove 44 can in principle have any desired shape, as long as said groove 44 leads from the first outlet opening 32 of the first medium channel 30 to the lateral surface 22, 24 of the cutting arrangement 6 and is at least partially covered by the insert seat 8. For example, groove 44 has an S-shape, as seen in FIGS. 3, 8, and 9. In the present case, the groove 44 is also rotationally symmetrical corresponding to a rotational symmetry of the cutting arrangement 6.

The previously specified embodiment, in which the second medium channel 34 is formed by means of a groove 44 on the rear side 18 of the cutting insert 6, can also be combined with a shim 42 which then completes the wall of the second media channel 34 instead of the insert seat 8 and instead completes the wall of the second medium. Or, the front side of the shim itself comprises a second groove for this purpose, which, for example, simply follows the same course as the groove 44 of the cutting insert 6. The concept of the groove 44 on the rear side 18 can advantageously also be applied in a manner similar to the shim 42, so that the letter then—irrespective of the configuration of the cutting insert 40—comprises a rear side in which the second medium channel 34 is formed by means of a groove 44. Accordingly, one possible general design is obtained by the second medium channel 34 being formed by a groove 44 which extends along a rear side of the cutting arrangement 6, with or without a shim. Similarly, it is also possible for the second medium channel 34 to be formed by a groove 44 that extends along a front side of the shim 42. In this case, the wall of the second medium channel 34 is formed by the groove 44 of the shim 42 on the one hand and the rear side of the cutting insert 40 on the other. The cutting insert 40 need not be specially designed. A conventional cutting insert 40 with a flat rear side can be used.

Specifically in the case of the shim 42, it is also possible to design the second medium channel 34 directly closed and not as an open groove 44, as described hereinabove. This is the case in the exemplary embodiment shown in FIGS. 11 to 15. Whereas the cutting insert 40 is, for example, a pressed part made of a special ceramic, the shim 42 is simply made of a high-strength steel and is in any case a harder material than the holder 4. For example, the shim is manufactured in an additive manufacturing method e.g. by means of 3D printing as a 3D printed part. In other words, nearly any desired course can be achieved for the second medium channel 34.

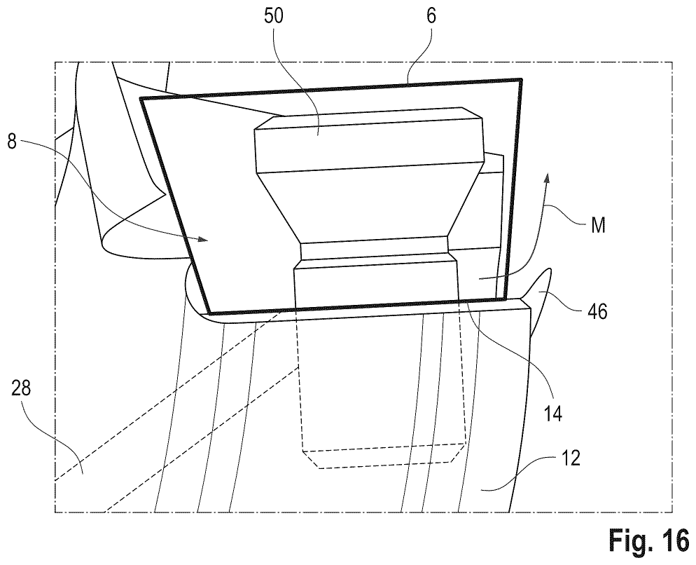

Optionally, the insert seat 8 and/or the cutting arrangement 6 comprise(s) a deflection contour 46, which is arranged such that the coolant and/or lubricant M, which emerges from the second outlet opening 38, strikes this deflection contour 46. One exemplary embodiment of this is shown in FIG. 16, in which the deflection contour 46 is formed on the insert seat 8 and as part of the holder 4. However, the deflection contour 46 can also be formed in a similar manner on the cutting insert 40 or on the shim 42. The deflection contour 46 then redirects, distributes, and/or atomizes the medium M immediately after it has emerged from the second medium channel 34. The deflection contour 46 is, for example, an edge, a projection, a spike, a step, a shoulder, or the like. Alternatively or in addition to the deflection contour 46, the lateral surface 22, 24 of the cutting arrangement 6 is designed accordingly for the purpose of redirecting, distributing, or atomizing the medium M, or the like.

The transfer of medium M from the first medium channel 28 to the second medium channel 34 can, in principle, occur in different ways, which can also be combined, e.g. by having multiple first outlet openings 32 distributed accordingly. In the exemplary embodiment in FIGS. 11 to 15, the cutting arrangement 6 adjoins, by way of a lateral surface 22, 24, the lateral surface 16 of the insert seat 8, and the first outlet opening 32 is also arranged in this lateral surface 16. The transfer of the medium M then takes place from lateral surface 16 to lateral surfaces 22, 24 and correspondingly in the radial or axial direction A, R. The second medium channel 34 merely extends sideways, from one lateral surface 22, 24 to another lateral surface 22, 24 of the cutting arrangement 6, but this course is not mandatory. Alternatively or additionally, the first outlet opening 32 is arranged in the base 14 of the insert seat 8, as in the exemplary embodiment in FIGS. 1 to 10. The transfer then takes place in the tangential direction (circumferential direction U). The second media channel 34 in this case extends, e.g., diagonally through the cutting arrangement 6, from the rear side 18 to the lateral surface 22, 24 (not shown), or as a groove 44 in the rear side 18 and then parallel to it.

The position of the first outlet opening 32 in the insert seat 8 is independent of the specific design of the cutting arrangement 6, with or without a shim 42, and also independent of the specific design of the second medium channel 34 (open groove 44 or closed channel and specific course). Accordingly, these individual aspects are shown in the drawings herein in two special combinations, but they can in principle be combined with one another as desired. For example, the arrangement of the first outlet opening 32 from FIGS. 1 to 6 can also be used in combination with a shim 42 as shown in FIGS. 11 to 15, and, conversely, the arrangement of the first outlet opening 32 from FIGS. 11 to 15 can also be used in FIGS. 1 to 6. In both cases, the first medium channel 34 can be formed by means of a groove 44, as shown in FIGS. 1 to 10, or as a channel, as shown in FIGS. 11 to 15. Accordingly, a channel as shown for the shim 42 can also be used directly in the cutting insert 40, and the shim 42 can be designed to comprise a groove 44, either on its front side, its rear side, or both.

In the embodiments shown herein, the insert seat 8 comprises a bore 48 (in this case an internal thread) for a fastening means 50 (in this case a screw) for mounting the cutting arrangement 6 on the holder 4. Optionally, the bore 48 comprises a depression 52 at the end facing the cutting arrangement 6, in which the first outlet opening 32 is at least partially arranged. The first medium channel 28 consequently leads into the depression 52 of the bore 48.

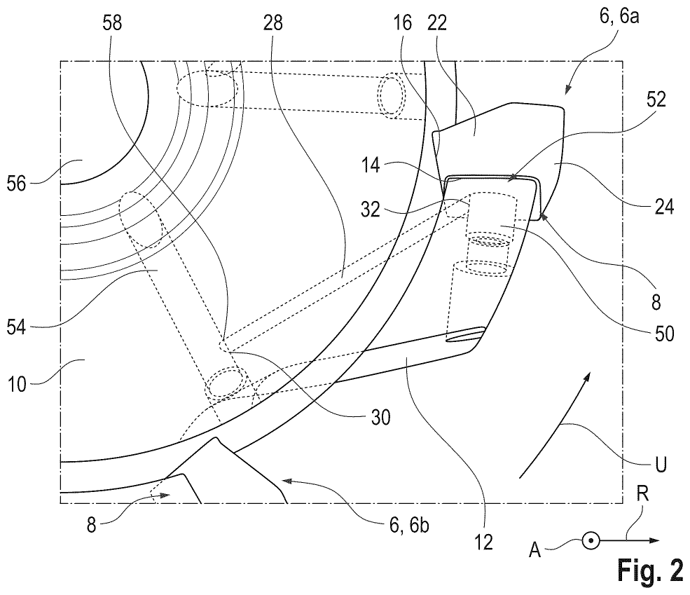

In the present case, the first medium channel 28 is completely straight, as can be seen in particular in FIGS. 2 and 11. The first medium channel 28 is not curved and is a simple bore in the holder 4. When manufacturing the tool 2, specifically the holder 4, the first medium channel 28 is simply created as a single bore in the holder 4. In the present case, the first medium channel 28 also has a constant diameter.

As already mentioned in the introductory section, the tools 2 shown herein each comprise multiple cutting arrangements 6. One of these is then designated as a first cutting arrangement 6a, and another as a second cutting arrangement 6b which runs behind the first cutting arrangement 6a in the circumferential direction U. In the exemplary embodiments shown herein, the holder 4 comprises a radial channel 54 for cooling the cutting surface in the second cutting arrangement 6b. The radial channel 54 extends in the radial direction R and starting from a central channel 56 of the holder 4. This central channel 56 extends along the longitudinal axis L and conducts the medium M to the radial channel 54. A corresponding radial channel 54 is formed in the holder 4 for each insert seat 8. The radial channel 54 comprises a (third) outlet opening which discharges the medium M onto the front side 20 of a respective cutting arrangement 6a, 6b. Accordingly, the radial channel 54 does open into the associated insert seat 8. The front side 20 corresponds to a cutting surface of the cutting arrangement 6a, 6b. In the present case, the radial channel 54 is also designed as a simple, straight bore, but it extends in a different direction to the first medium channel 28. The first medium channel 28 then starts from the radial channel 54, meaning that a branch 58 for the medium M is formed within the holder 4, at which a first part of the medium M is conducted to the cutting surface of the first cutting arrangement 6a, and a second part of the medium M is branched off to the clearance surface of the second cutting arrangement 6b.

1. A tool,
a. which comprises a holder,
b. which comprises at least one cutting arrangement for processing a workpiece,
c. wherein the holder comprises at least one insert seat in which the cutting arrangement is mounted,
d. wherein the holder comprises a first medium channel for conducting a coolant and/or lubricant,
e. wherein the first medium channel comprises a first outlet opening that is at least partially arranged within the insert seat,
f. wherein the cutting arrangement comprises a second medium channel, which is connected to the first medium channel and which comprises at least one second outlet opening arranged in a lateral surface of the cutting arrangement.

2. The tool according to claim 1,
wherein the cutting arrangement is designed to be integral, specifically as a cutting insert.

3. The tool according to claim 2,
wherein the second medium channel is formed by means of a groove which extends along a rear side of the cutting insert.

4. The tool according to claim 1,
wherein the cutting arrangement is designed in a multi-part manner,
specifically as a combination consisting of a cutting insert and a shim, wherein the shim is arranged between the cutting insert and a base of the insert seat,
wherein the second medium channel spans through the shim.

5. The tool according to claim 1,
wherein the insert seat and/or the cutting arrangement comprise(s) a deflection contour, which is arranged such that the coolant and/or lubricant exiting the second outlet opening strikes the deflection contour.

6. The tool according to claim 1,
wherein the insert seat comprises a lateral surface, which adjoins the cutting arrangement and in which the first outlet opening is arranged.

7. The tool according to claim 1,
wherein the insert seat comprises a base, which adjoins the cutting arrangement and in which the first outlet opening is arranged.

8. The tool according to claim 1,
wherein the insert seat comprises a bore for a fastening means for mounting the cutting arrangement, wherein the bore comprises a depression in the direction of the cutting arrangement, in which depression the first outlet opening is arranged.

9. The tool according to claim 1,
wherein the first medium channel is designed to be straight.

10. The tool according to claim 1,
wherein the at least one cutting arrangement is a first cutting arrangement,
wherein the tool comprises a second cutting arrangement which runs behind the first cutting arrangement,
wherein the holder comprises a radial channel for cooling the cutting face in the second cutting arrangement,
wherein the first medium channel extends from the radial channel.

11. The tool according to claim 1,
wherein this is a rotary tool, in particular a milling and/or drilling tool.

12. A cutting arrangement for a tool according to claim 1.

13. A method for manufacturing a tool according to claim 1,
wherein the first medium channel is manufactured as a bore in the holder.
